(19) United States
(12) Patent Application Publication
(10) Pub. No.: US 2018/0188935 A1
(43) Pub. Date: Jul. 5, 2018

(54) METHOD AND ELECTRONIC DEVICE FOR MANAGING NOTIFICATIONS IN A NOTIFICATION PANEL

(71) Applicant: SAMSUNG ELECTRONICS CO., LTD., Suwon-si (KR)

(72) Inventors: Amandeep SINGH, Utta Pradesh (IN); Anindya DUTTA, Jharkhand (IN); Vikas CHOPRA, Punjab (IN); Dhananjay Laxmikant GOVEKAR, Maharashtra (IN); Munwar Shamsher KHAN, Maharashtra (IN); Shantanu Kumar MEHER, Karnataka (IN); Mangal SINGH, Chandigarh (IN); Pooja LASHKARE, Madhya Pradesh (IN)

(73) Assignee: SAMSUNG ELECTRONICS CO., LTD., Suwon-si (KR)

(21) Appl. No.: 15/618,827

(22) Filed: Jun. 9, 2017

(30) Foreign Application Priority Data
Dec. 30, 2016 (IN) 201641019802

(51) Int. Cl. G06F 3/0484; H04L 29/08

(52) U.S. Cl. CPC G06F 3/04847; G06F 3/04842; H04L 67/22

(57) ABSTRACT

A method and an electronic device for managing notifications in a notification panel. The method includes receiving a notification associated with an application. Further, the method includes assigning the notification to a user defined group based on a plurality of parameters. Further, the method includes displaying, in the notification panel of the electronic device, a graphical element corresponding to the user defined group. Further, the method includes detecting a first user input, the first user input including a user selection of the graphical element, detecting a second user input, and applying an action to the notification based on the first user input and the second user input.

### CROSS-REFERENCE TO RELATED APPLICATION

This application claims the benefit of priority from Indian Patent Application No. 201641019802, filed on Jun. 9, 2016 and Indian Patent Application No. 201641019802, filed on Dec. 30, 2016, in the Indian Patent Office, the disclosures of which are incorporated herein by reference in their entireties.

### BACKGROUND

### 1. Field

Apparatuses and methods consistent with exemplary embodiments broadly relate to managing notifications, and more particularly, to a method and an apparatus thereof for managing notifications in a notification panel.

### 2. Description of Related Art

With the increasing use of smartphones, a steep increase in the use of third party applications (i.e., primarily utility applications and social media applications) has been observed. This has further led to a subsequent increase in number of notifications received on the smartphones, i.e., both application notifications and system notifications. Further, depending on smartphone usage, a user may receive many notifications in a day. Such notifications may be personal or business related. For example, the user may receive notifications such as text messages, voicemails, instant messages, status updates from social networking sites (SNSs), E-mails, Rich Site Summary (RSS) updates, game messages, weather updates, computing device maintenance messages, and other types of notifications.

Further, such notifications are displayed to the user in a list format, in which the notifications are sorted based on receipt times of the notifications, e.g., most recent notifications appear at the top of a notification list. The user's interaction with the notification list on a smartphone can be cumbersome due to various factors, such as typically limited display space on a device, the tendency of notification lists to grow over time, and the inability for the user to quickly discriminate between important and unimportant notifications. In conventional systems and methods, all notifications are arranged in chronological order and are not arranged as per the user's needs and priority.

### SUMMARY

Accordingly, the exemplary embodiments provide a method of managing notifications in a notification panel of the electronic device.

Additional aspects will be set forth in part in the description which follows and, in part, will be apparent from the description, or may be learned by practice of exemplary embodiments. Exemplary embodiment may overcome the above disadvantages and other disadvantages not described above. Also, exemplary embodiments are not required to overcome the disadvantages described above, and an exemplary embodiment may not overcome any of the problems described above.

According to an aspect of an exemplary embodiment, a method includes receiving, by a notification manager of an electronic device, a notification associated with an application, assigning, by the notification manager, the notification to a user defined group based on a plurality of parameters, displaying, in a notification panel of the electronic device, a graphical element corresponding to the user defined group, detecting, by the notification manager, a first user input which includes a selection of the graphical element, detecting, by the notification manager, a second user input, applying, by the notification manager, an action to the notification based on the first user input and the second user input. In the method, the action may include one or more of hiding at least one of the notification and another notification for at least one other application assigned to the user defined group, unhiding said at least one of the notification and said another notification for the at least one other application assigned to the user defined group, muting at least one of a first notification alert for the application and a second notification alert for the at least one other application assigned to the user defined group, unmuting said at least one of the first notification alert for the application and the second notification alert for the at least one other application assigned to the user defined group, removing said at least one of the application and the at least one other application from the user defined group, and generating at least one to-do notification.

In an exemplary embodiment, the receiving may include receiving a plurality of notifications, the assigning includes assigning the notifications to at least one of the user defined group and another user defined group, and the method may further include dynamically organizing the plurality of notifications in user defined groups based on a priority level associated with each of the notifications.

In an exemplary embodiment, the plurality of parameters may include at least one of a user action, a user activity, notification content, a user location, a current time and an application type.

In an exemplary embodiment, the graphical element may include an indicator indicating a number of notifications unread by the user.

In an exemplary embodiment, the receiving may include receiving a plurality of notifications, the assigning may include assigning the notifications to at least one of the user defined group and another user defined group, and the method may further include automatically arranging the user defined groups based on at least one of usage of the notifications and receipt times of the notifications.

In an exemplary embodiment, the user defined group comprises an indicator indicating whether the user defined group has been accessed by the user after receiving at least one new notification.

Exemplary embodiments herein similarly provide the above management method to managing notifications in an edge portion of the electronic device. Accordingly, an exemplary embodiment provides an electronic device for managing in a notification panel of the electronic device which includes a notification manager configured to receive a notification associated with an application, assign the notification to a user defined group based on a plurality of parameters, display, in the notification panel of the electronic device, a graphical element corresponding to the user defined group, detect a first user input including a user selection of the graphical element, detect a second user input, and apply an action to the notification based on the first user input and the second user input. The action is selected from one of more of hiding at least one of the notification and a notification for at least one other application assigned to the user defined group, unhiding at least one of the notification and the notification for the at least one other application assigned to the user defined group, muting at least one of a notification alert for the application and a notification alert for the at least one other application assigned to the user defined group, unmuting at least one of the notification alert for the application and the notification alert for the at least one other application assigned to the user defined group, removing at least one of the application and the at least one other application from the user defined group, and generating at least one to-do notification.

In an exemplary embodiment, the electronic device is further configured to receive a plurality of notifications, assign the notifications to at least one of the user defined group and another user defined group, and dynamically organize the notifications in the user defined groups based on a priority level associated with each of the notifications.

The plurality of parameters comprises at least one of a user action, a user activity, notification content, a user location, a current time, and an application type.

In an exemplary embodiment, the electronic device is configured to display, based on at least one of the plurality of parameters, an application for recommending at least one place.

In an exemplary embodiment, the graphical element may include an indicator indicating a number of notifications unread by the user.

In an exemplary embodiment, the electronic device may further be configured to receive a plurality of notifications, assign the notifications to at least one of the user defined group and another user defined group, and automatically arrange the user defined groups based on at least one of usage of the notifications and receipt times of the notifications.

In an exemplary embodiment, the user defined group comprises an indicator indicating whether the user defined group has been accessed by the user after receiving at least one new notification.

Accordingly to an aspect of exemplary embodiments, an electronic device for managing notifications in an edge portion of the electronic device is provided. The electronic device includes a notification manager configured to receive a notification associated with an application, assign the notification to a user defined group based on a plurality of parameters, display, in the edge portion of the electronic device, a graphical element corresponding to the user defined group, detect a first user input including a selection of the graphical element, detect a second user input, and apply an action to the notification based on the first user input and the second user input. The action is selected from one or more of: hiding at least one of the notification and a notification for at least one other application assigned to the user defined group, unhiding at least one of the notification and the notification for the at least one other application assigned to the user defined group, muting at least one of a notification alert for the application and a notification alert for the at least one other application assigned to the user defined group, unmuting at least one of the notification alert for the application and the notification alert for the at least one other application assigned to the user defined group, removing at least one of the application and the at least one other application from the user defined group, and generating at least one to-do notification.

Accordingly to yet another exemplary embodiment, a non-transitory computer readable medium is provided storing a computer executable program code. The computer executable program code, when executed by a computer, performs the following operations: receiving, by a notification manager, a notification associated with an application, assigning, by the notification manager, the notification to a user defined group based on a plurality of parameters, displaying, in the notification panel of the electronic device, a graphical element corresponding to the user defined group, detecting, by the notification manager, a first user input which includes a selection of the graphical element, detecting, by the notification manager, a second user input; and applying, by the notification manager, an action to the notification based on the first user input and the second user input, wherein the action is selected from one or more of: hiding at least one of the notification and a notification for at least one other application assigned to the user defined group, unhiding at least one of the notification and the notification for the at least one other application assigned to the user defined group, muting at least one of a notification alert for the application and a notification alert for the at least one other application assigned to the user defined group, unmuting at least one of the notification alert for the application and the notification alert for the at least one other application assigned to the user defined group, removing at least one of the application and the at least one other application from the user defined group, and generating at least one to-do notification.

These and other aspects of the exemplary embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of exemplary embodiments herein without departing from the spirit thereof, and exemplary embodiments herein include all such modifications.

### BRIEF DESCRIPTION OF THE DRAWINGS

The above and other aspects of one or more exemplary embodiments will become more apparent by reference to exemplary embodiments thereof which are illustrated in the appended drawings. Understanding that these drawings depict only exemplary embodiments and are not therefore to be considered to be limiting of the scope of the disclosure, the principles herein are described and explained with additional specificity and detail through the use of the accompanying drawings, in which: Exemplary embodiments are illustrated in the accompanying drawings, throughout which same reference numerals or symbols indicate corresponding parts in the various drawings. Exemplary embodiments herein will be better understood from the following description with reference to the drawings, in which:

FIG. 1 is a block diagram illustrating an electronic device for managing notifications in a notification panel, according to an exemplary embodiment;

FIG. 2 is a block diagram illustrating a notification manager, according to an exemplary embodiment;

FIG. 3 is a flow chart illustrating a method of managing notifications in a notification panel of an electronic device, according to an exemplary embodiment;

FIG. 4 is a flow chart illustrating various operations performed for managing notifications, according to an exemplary embodiment;

FIG. 5 is a flow chart illustrating a method of managing notifications in an edge portion of an electronic device, according to an exemplary embodiment;

FIG. 6 is a flow chart illustrating various operations performed for clearing notifications in a notification panel of an electronic device, according to an exemplary embodiment;

FIG. 7 is a flow chart illustrating various operations performed for categorizing applications when a smart notifier application is enabled, according to an exemplary embodiment;

FIG. 8 is a flow chart illustrating various operations performed for muting/un-muting user defined groups, according to an exemplary embodiment;

FIG. 9 is a flow chart illustrating various operations for hiding/un-hiding user defined groups, according to an exemplary embodiment;

FIGS. 10A-10H are views illustrating a scenario in which a user enters a sequence of inputs to enable a smart notifier application and manage the notifications in a notification panel of an electronic device, according to an exemplary embodiment;

FIG. 11 is a view illustrating a scenario in which a graphical element for each user defined group is displayed in a notification panel of an electronic device, according to an exemplary embodiment;

FIGS. 12A-12D are views illustrating a scenario in which indicators for user defined groups indicate whether the user defined groups have been accessed by a user following the receipt of new notifications, according to an exemplary embodiment;

FIGS. 13A-13C are views illustrating a scenario in which a user edits applications assigned to user defined groups, according to an exemplary embodiment;

FIGS. 14A-14C are views illustrating a scenario in which a user is provided with an option to clear notifications according to user defined group, according to an exemplary embodiment;

FIGS. 15A and 15B are views illustrating a scenario in which a user enters an input to hide/unhide notifications for user defined groups, according to an exemplary embodiment;

FIGS. 16A and 16B are views illustrating a scenario in which a user enters an input to mute/un-mute notification alerts for user defined groups, according to an exemplary embodiment;

FIGS. 17A-17D are views illustrating a scenario in which a user is provided with options to remove one or more applications from a user defined group, according to an exemplary embodiment;

FIGS. 18A-18B are views illustrating a scenario in which a user can arrange a user defined group in a notification panel, according to an exemplary embodiment;

FIG. 19 is a view illustrating a scenario in which a user creates to-do notifications, according to an exemplary embodiment;

FIG. 20 is a view illustrating a scenario for managing notifications in an edge portion of an electronic device, according to an exemplary embodiment;

FIG. 21 is a view illustrating a scenario in which a user is provided with multiple options for muting user defined groups, arranging the user defined groups, and exporting settings to another electronic device, according to an exemplary embodiment;

FIG. 22 is a view illustrating a scenario in which a smart notifier application is applied to a wearable device, according to an exemplary embodiment; and

FIG. 23 is a block diagram illustrating a computing environment implementing the method of managing notifications in a notification panel or edge portion of an electronic device, according to an exemplary embodiment.

### DETAILED DESCRIPTION OF EXEMPLARY EMBODIMENTS

Various exemplary embodiments will now be described in detail with reference to the accompanying drawings. In the following description, specific details such as detailed configuration and components are merely provided to assist the overall understanding of exemplary embodiments. Therefore, it should be apparent to those skilled in the art that various changes and modifications of exemplary embodiments described herein can be made without departing from the scope and spirit of the present disclosure. In addition, descriptions of well-known functions and constructions are omitted for clarity and conciseness.

Also, various exemplary embodiments described herein are not necessarily mutually exclusive, as some exemplary embodiments can be combined with one or more other exemplary embodiments to form new exemplary embodiments.

Herein, the term “or” as used herein, refers to a non-exclusive or, unless otherwise indicated. The examples used herein are intended merely to facilitate an understanding of ways in which exemplary embodiments herein can be practiced and to further enable those skilled in the art to practice exemplary embodiments herein. Accordingly, examples should not be construed as limiting the scope of exemplary embodiments herein.

As is traditional in the field, exemplary embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the exemplary embodiments may be physically separated into two or more interacting and discrete blocks without departing from the scope of the disclosure. Likewise, the blocks of the exemplary embodiments may be physically combined into more complex blocks without departing from the scope of the disclosure.

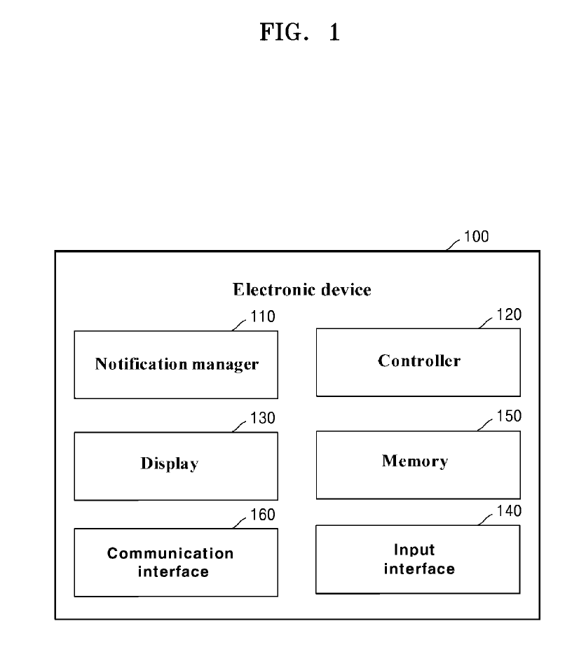

Referring now to the drawings, and more particularly to FIGS. 1 through 23, where similar reference characters denote corresponding features consistently throughout the drawings, exemplary embodiments are shown.

FIG. 1 is a block diagram of an electronic device 100 for managing notifications in a notification panel, according to an exemplary embodiment. In an exemplary embodiment, the electronic device 100 can be, for example, a laptop, a desktop computer, a mobile phone, a smart phone, Personal Digital Assistants (PDAs), a tablet, a phablet, a consumer electronic device, a dual display device, a head mounted display, a Virtual Reality (VR) device, a wearable device, an Internet of Things (IoT) device, or any other electronic device. The electronic device 100 comprises a notification manager 110, a controller 120, a display 130, an input interface 140, a memory 150, and a communication interface 160. The notification manager 110 can be configured to receive a notification associated with an application. The application can be, for example, a Message application, Social Networking Site (SNS) application, E-Mail application, Gallery application, Call application, or any other application available in the electronic device 100. Further, the notification manager 110 can be configured to assign the notification to a user defined group (e.g., identify a user defined group which the notification belongs to) based on a plurality of parameters. The plurality of parameters includes, for example, at least one of a user action, user activity, notification content, user location, current time and application type. In an exemplary embodiment, the notification manager 110 may receive a plurality of notifications, each assigned to a separate application, assign the notifications to at least one of the user defined group and another user defined group, and dynamically organize the notifications in the user defined groups based on a priority level associated with each of the notifications.

In an exemplary embodiment, the electronic device may display, based on at least one of the plurality of parameters, an application for recommending at least one place. For instance, the electronic device may recommend a restaurant which serves spaghetti dishes close to the user if the content of the notification indicates “noodle”, “spaghetti” and it is around lunch time or dinner time.

In an exemplary embodiment, the user defined group includes an indicator indicating a number of notifications not viewed by the user. In an exemplary embodiment, the user defined group is automatically arranged based on at least one of usage and time. Further, in an exemplary embodiment, the notification manager 110 can be configured to display a graphical element corresponding to the user defined group, the graphical element including a graphical representation of the notification. In another exemplary embodiment, the notification manager 110 can be configured to display the graphical element for the user defined group including the graphical representation of the notification in an edge portion of the electronic device 100. Further, the notification manager 110 can be configured to detect a user defined group selected by a user in the notification panel; and detect an input entered by the user in the selected user defined group.

Further, the notification manager 110 can be configured to perform an action on the notification displayed in the selected user defined group. The action includes any one of hiding one or more notifications assigned to the user defined group, unhiding one or more applications assigned to the user defined group, muting a notification alert for one or more applications assigned to the user defined group, unmuting a notification alert for one or more applications assigned to the user defined group, removing one or more applications from the user defined group, and creating at least one to-do notification, but is not limited thereto. In another exemplary embodiment, the user defined group includes an indicator indicating whether the user defined group is accessed by the user after receiving at least one new notification. The functionalities performed by the notification manager 110 can also be performed by the controller 120 without departing from the scope of an exemplary embodiment.

The display 130 displays the graphical element for the user defined group. The memory 150 may include one or more computer-readable storage media. The memory 150 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 150 may, in some examples, be considered a non-transitory storage medium. The term “non-transitory” may indicate that the storage medium is not embodied in a carrier wave or a propagated signal. However, the term “non-transitory” should not be interpreted that the memory 150 is non-movable. In some examples, the memory 150 can be configured to store larger amounts of information than the memory. In certain examples, a non-transitory storage medium may store data that can, over time, change (e.g., in Random Access Memory (RAM) or cache). The communication interface 160 communicates internally with the units(devices) and externally with networks.

Unlike conventional systems and methods, the proposed method is used to organize and manage the notifications in a more efficient way by categorizing the applications into different user defined groups according to an exemplary embodiment.

FIG. 1 shows a limited overview of the electronic device 100 but, it is to be understood that another exemplary embodiment is not limited thereto. Further, the electronic device 100 can include different units or components communicating among each other along with other hardware or software components. By way of illustration, both an application running on the electronic device 100 and the electronic device 100 can be the component. In an exemplary embodiment according to FIG. 1, the input interface 140 may be a keyboard, a mouse, a touch screen, and so on. In an exemplary embodiment, the input interface is a component which receives user input. A communication interface 160 may include a combination of hardware and software, such as a network card, which communicates with a network. The controller 120, for example, is a processor or a micro-processor.

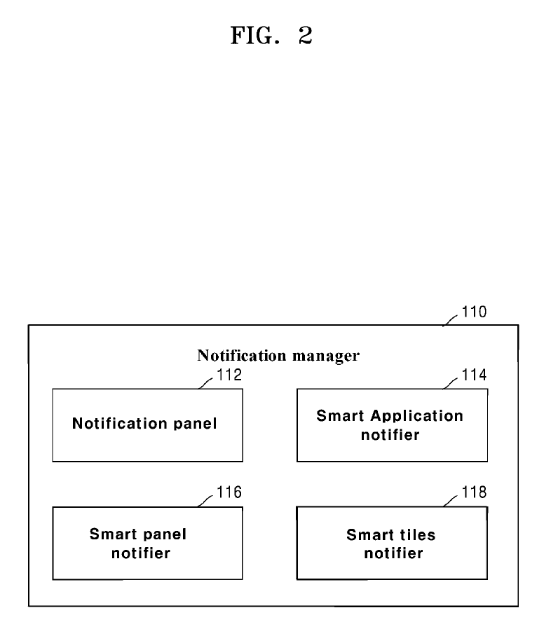

FIG. 2 is a block diagram of the notification manager 110, according to an exemplary embodiment. In an exemplary embodiment, the notification manager 110 includes a notification panel 112, a smart application notifier 114, a smart panel notifier 116, and a smart tiles notifier 118.

The notification panel 112 can be configured to display notifications vertically. The smart application notifier 114 can be configured to list groups horizontally. The groups can be selected to view different notifications and will be described in more detail below according to exemplary embodiments. The smart panel notifier 116 can be used as an interface for managing the groups and applications belonging thereto. The smart tiles notifier 118 can be configured to show an application icon, read/unread notification indicator, and total notification count in each group. All the foregoing components of the notification panel 112, the smart application notifier 114, the smart panel notifier 116, and the smart tiles notifier 118 are implemented by at least one hardware processor. Further, the additional functionalities of the notification manager 110 are explained in conjunction with FIG. 1.

In the conventional systems, different types of notifications (i.e., system notifications, third party notifications, ongoing notifications, or the like) are listed together in a single list, which makes finding desired notifications from the list difficult. Scrolling an entire list of notifications to find a desired notification can be time consuming without the ability to distinguish notifications based on type or priority.

Further, in the conventional systems, there is no option for clearing select groups of notifications from a list of all notifications. For example, if the user only wants to clear all notifications related to social media, the user has to view all notifications in chronological order and clear the notifications related to social media one-by-one.

Unlike conventional systems and methods, exemplary embodiments provide the user with options to clear notifications for select user defined groups or “ALL” notifications in one click. In exemplary embodiments, all applications installed on the electronic device 100 are mapped to various groups, for example, four groups. However, exemplary embodiments are not limited thereto, and the user can create customizable groups and can categorize applications to any of the created user defined groups. Further, exemplary embodiments provide the user with options to hide/unhide and mute/un-mute notifications for all applications based on user defined group.

FIG. 2 is a block diagram illustrating the notification manager 110 according to an exemplary embodiment. However, it is to be understood that exemplary embodiments are not limited thereto. Further, the notification manager 110 can include different components communicating with one another, along with other hardware or software components. By way of illustration, both the notification manager 110 and an application running on the notification manager 110 can be considered components.

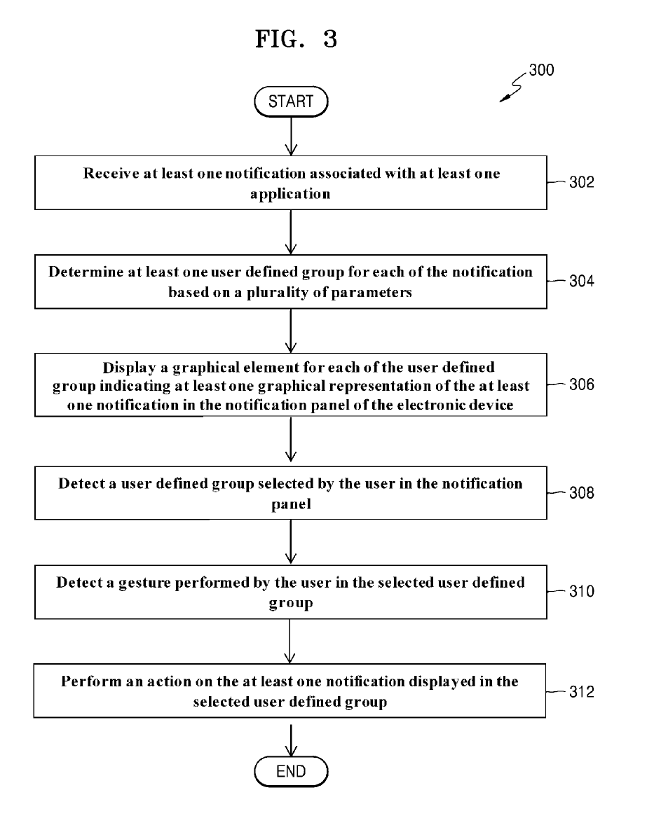

FIG. 3 is a flow chart 300 illustrating a method of managing notifications in a notification panel 112 of the electronic device 100, according to an exemplary embodiment.

In operation 302, the method includes receiving a notification associated with an application. It is to be understood that one or more notifications may be received, and each of the notifications may be associated with the same application or different applications. In operation 304, the method includes determining and/or assigning the notification to a user defined group based on a plurality of parameters. That is, the method may identify a user defined group which the notification belongs to. In an exemplary embodiment, the method includes receiving a plurality of notifications, assigning the notifications to at least one of the user defined group and another user defined group, and dynamically organizing the plurality of notifications in the user defined groups based on a priority level associated with each of the notifications. In an exemplary embodiment, the plurality of parameters includes at least one of user activity, notification content, user location, and application type, but is not limited thereto.

In operation 306, the method includes displaying, in the notification panel 112 of the electronic device 100, a graphical element corresponding to the user defined group. The graphical element may include an indicator indicating the number of notifications unread by the user. In an exemplary embodiment, the method may include receiving a notification and assigning the notification to a user defined group. The method may include receiving a plurality of notifications, assigning the notifications to at least one of the user defined group and another user defined group, and automatically arranging the user defined groups based on at least one of usage of the notifications and receipt times of the notifications.

In operation 308, the method includes detecting a first user input in the notification panel 112. The first user input may include a user selection of a graphical element displayed or included in the notification panel 112. According to the method of an exemplary embodiment, detecting the first user input may include detecting a user selection of a graphical element (for example, a graphical element included among graphical elements displayed in the notification panel 112) and identifying a user defined group corresponding to the selected graphical element.

In operation 310, the method includes detecting a second user input. The second user input may be an input entered by the user with respect to the selected user defined group (i.e., the selected graphical element). In an exemplary embodiment, the user defined group may include an indicator indicating whether the user defined group has been accessed by the user after receiving at least one new notification.

In operation 312, the method includes applying an action to the notification based on the second user input. The action may be, for example, hiding one or more notifications assigned to the user defined group, unhiding one or more applications assigned to the user defined group, muting a notification alert for one or more applications assigned to the user defined group, unmuting a notification alert for one or more applications assigned to the user defined group, removing one or more applications from the user defined group, and creating at least one to-do notification, but is not limited thereto.

According to the method of an exemplary embodiment, the notification manager 110 may perform the above operations described in FIG. 3.

Various actions, acts, blocks, steps, or the like in the flow chart 300 may be performed in the order presented, in a different order or simultaneously. Further, in some exemplary embodiments, actions, acts, blocks, steps, or the like may be omitted, added, modified, skipped, or the like without departing from the scope of an inventive concept.

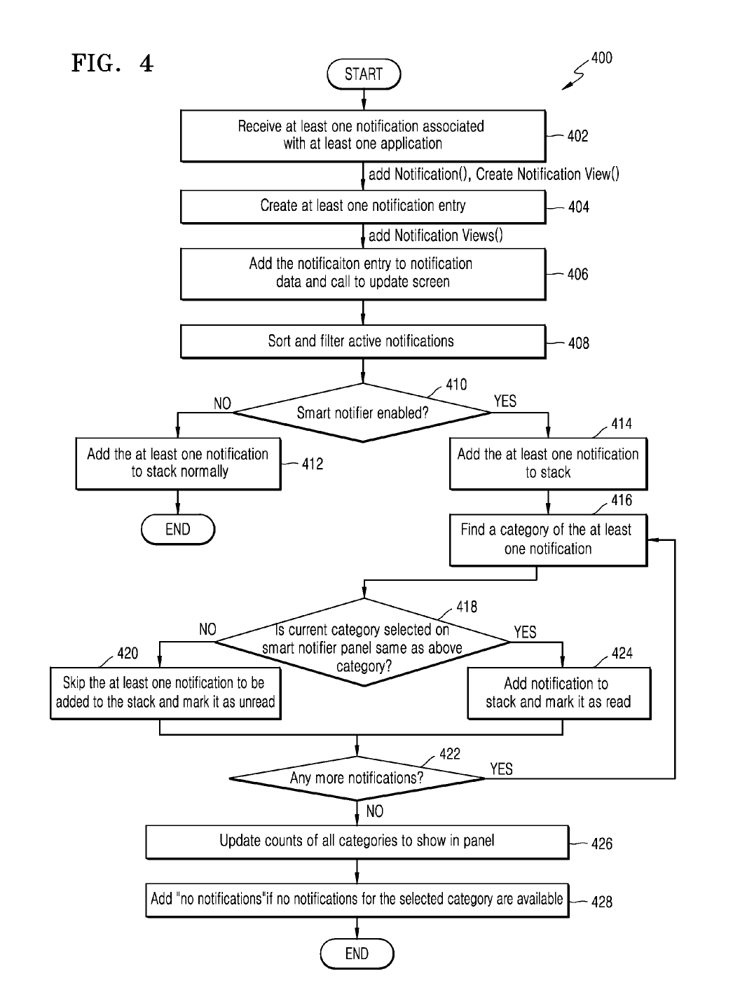

FIG. 4 is a flow chart 400 illustrating various operations performed for managing notifications, according to an exemplary embodiment.

In operation 402, the method includes receiving a notification associated with an application. It is to be understood that one or more notifications may be received.

In operation 404, the method includes creating a notification entry. It is to be understood that one or more notification entries may be created.

In operation 406, the method includes adding the notification entry to notification data and call to update screen.

In operation 408, the method includes sorting and filtering active notifications.

In operation 410, the method includes determining whether the smart notifier application is enabled.

Upon determining that the smart notifier application is not enabled, the method proceeds to operation 412 of adding a notification to a notification stack, as is usually performed (e.g., adding the notification to a notification list chronologically) and the process is then complete.

Upon determining that the smart notifier application is enabled, the method proceeds to operation 414 of adding a notification to a notification stack, as is usually performed, followed by an operation 416 of identifying a category associated with the notification.

In operation 418, the method includes determining whether a category currently selected on the smart panel notifier 116 is the same as the category identified in operation 416.

Upon determining the categories are the same, the method proceeds to operation 420 of marking the notification as unread and not adding the notification to the stack.

Upon determining the categories are not the same, the method proceeds to operation 424, which includes marking the notification as read and adding the notification to the stack.

In operation 422, the method includes determining whether additional notifications are available.

Upon determining additional notifications are available, the method loops back to operation 416.

Upon determining no further notifications are available, the method proceeds to operation 426 of updating notification counts for all categories (i.e., groups) to be shown in the notification panel 112.

In operation 428, when there are no further notifications for the selected category, the method includes outputting a message indicating the same. For example, operation 428 may include outputting a “no notifications” message or alert.

According to the method of an exemplary embodiment, the notification manager 110 may perform the above operations described in FIG. 4.

Various actions, acts, blocks, steps, or the like in the flow chart 400 may be performed in the order presented, in a different order or simultaneously. Further, in some exemplary embodiments, actions, acts, blocks, steps, or the like may be omitted, added, modified, skipped, or the like without departing from the scope of an inventive concept.

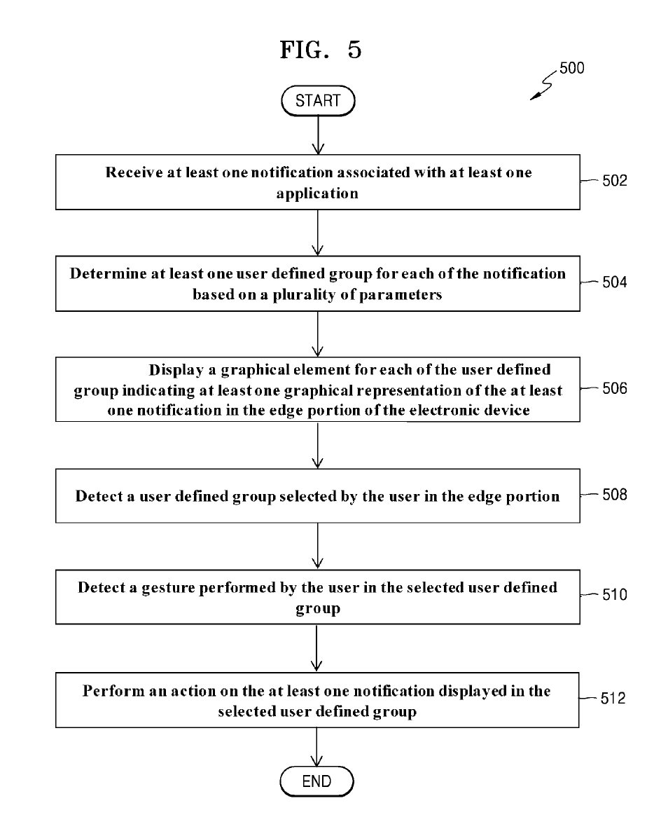

FIG. 5 is a flow chart 500 illustrating a method of managing notifications in an edge portion of the electronic device 100 according to an exemplary embodiment.

In operation 502, the method includes receiving a notification associated with an application.

In operation 504, the method includes assigning the notification to a user defined group based on a plurality of parameters. In an exemplary embodiment, the method includes receiving a plurality of notifications, assigning the notifications to at least one of the user defined group and another user defined group, and dynamically organizing the plurality of notifications in the user defined groups based on a priority level associated with each of the notifications. In an exemplary embodiment, the plurality of parameters includes at least one of user activity, notification content, user location, and application type, but is not limited thereto.

In operation 506, the method includes displaying, in the edge portion of the electronic device 100, a graphical element corresponding to the user defined group. The graphical element may include an indicator indicating the number of notifications unread by the user. In an exemplary embodiment, the method may include receiving a plurality of notifications, assigning the notifications to at least one of the user defined group and another user defined group, and automatically arranging the user defined groups based on at least one of usage of the notifications and receipt times of the notifications.

In operation 508, the method includes detecting a first user input in the edge portion. The first user input may include a user selection of a graphical element displayed or included in the edge portion. According to the method, detecting the first user input may include detecting a user selection of a graphical element (for example, a graphical element included among graphical elements displayed in the notification panel 112) and identifying a user defined group corresponding to the selected graphical element.

In operation 510, the method includes detecting a second user input. The second user input may be an input entered by the user with respect to the selected user defined group (i.e., the selected graphical element). In an exemplary embodiment, the user defined group may include an indicator indicating whether the user has accessed the user defined group after receiving at least one new notification.

In operation 512, the method includes applying an action to the notification based on the second user input. The action may be, for example, hiding one or more notifications assigned to the user defined group, unhiding one or more applications assigned to the user defined group, muting a notification alert for one or more applications assigned to the user defined group, unmuting a notification alert for one or more applications assigned to the user defined group, removing one or more applications from the user defined group, and creating at least one to-do notification, but is not limited thereto.

According to the method of an exemplary embodiment, the notification manager 110 may perform the above operations described in FIG. 5.

Various actions, acts, blocks, steps, or the like in the flow chart 500 may be performed in the order presented, in a different order or simultaneously. Further, in some exemplary embodiments, actions, acts, blocks, steps, or the like may be omitted, added, modified, skipped, or the like without departing from the scope of an inventive concept.

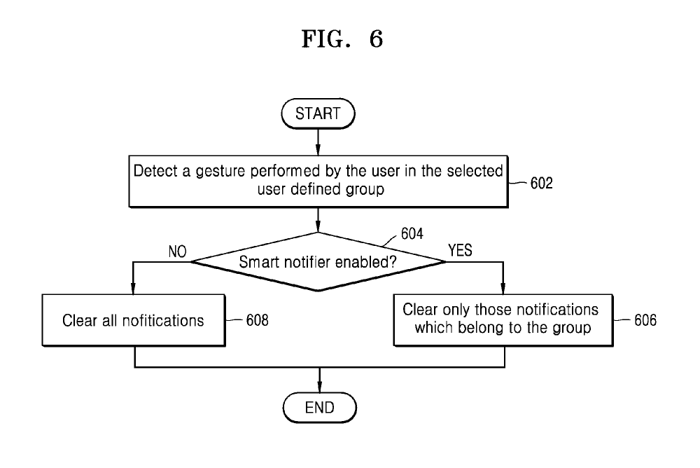

FIG. 6 is a flow chart 600 illustrating various operations performed for clearing notifications in the notification panel 112 of the electronic device 100, according to an exemplary embodiment.

In operation 602, the method includes detecting an input or inputs entered by the user with respect to a user defined group (e.g., a user input selecting a graphical element corresponding to a user defined group and a user input for clearing notifications). According to the method of an exemplary embodiment, the notification manager 110 may detect the inputs entered by the user.

In operation 604, the method includes determining whether the smart notifier application is enabled.

Upon determining that the smart notifier application is enabled, the method proceeds to operation 606 of only clearing the notifications which belong to the user defined group. Upon determining that the smart notifier application is not enabled, the method proceeds to operation 608 of clearing all notifications, regardless of user defined groups. According to the method of an exemplary embodiment, the notification manager 110 may clear the notifications.

Various actions, acts, blocks, steps, or the like in the flow chart 600 may be performed in the order presented, in a different order or simultaneously. Further, in some exemplary embodiments, actions, acts, blocks, steps, or the like may be omitted, added, modified, skipped, or the like without departing from the scope of an inventive concept.

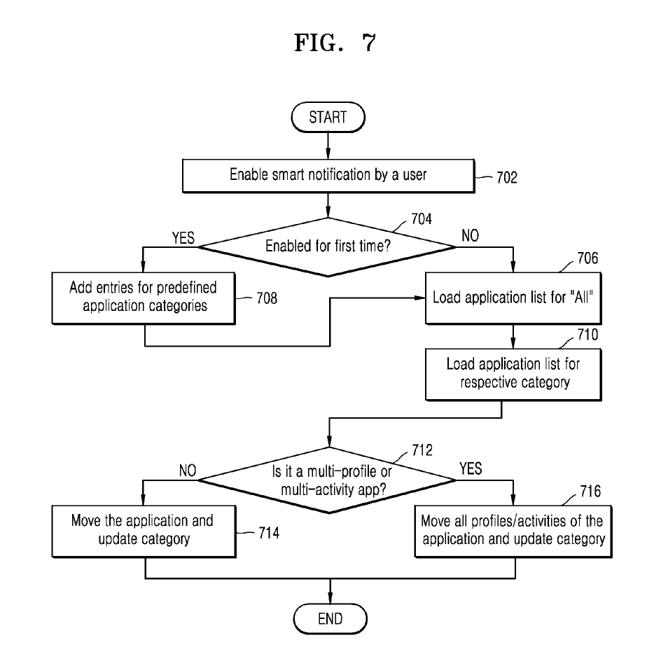

FIG. 7 is a flow chart 700 illustrating various operations performed for categorizing applications when the smart notifier application is enabled, according to an exemplary embodiment.

In operation 702, the method includes enabling the smart notifier application, e.g., enabling the smart notifier application based on a user input.

In operation 704, the method includes determining whether the smart notifier application is being enabled for the first time.

Upon determining that the smart notifier application is not being enabled for the first time, the method proceeds to operation 706 of loading application list for “ALL” (e.g., loading an application list inclusive of all applications installed on the electronic device 100). Upon determining that the smart notifier application is being enabled for the first time, the method first proceeds to operation 708 of adding entries for predefined application categories, and then proceeds to operation 706.

In operation 710, the method includes loading the application list for respective categories.

In operation 712, the method determines whether applications in the application list are multi-profile (i.e., multi-activity) applications.

Upon determining that an application is not a multi-profile (i.e., multi-activity) application, the method proceeds to operation 714 of moving the application to a category (i.e., user defined group) and updating the category. Upon determining that an application is a multi-profile (i.e., multi-activity) application, the method proceeds to operation 716 of moving all profiles/activities of the application to another category and updating the category.

According to the method of an exemplary embodiment, the notification manager 110 may perform the above operations described in FIG. 7.

Various actions, acts, blocks, steps, or the like in the flow chart 700 may be performed in the order presented, in a different order or simultaneously. Further, in some exemplary embodiments, actions, acts, blocks, steps, or the like may be omitted, added, modified, skipped, or the like without departing from the scope of an inventive concept.

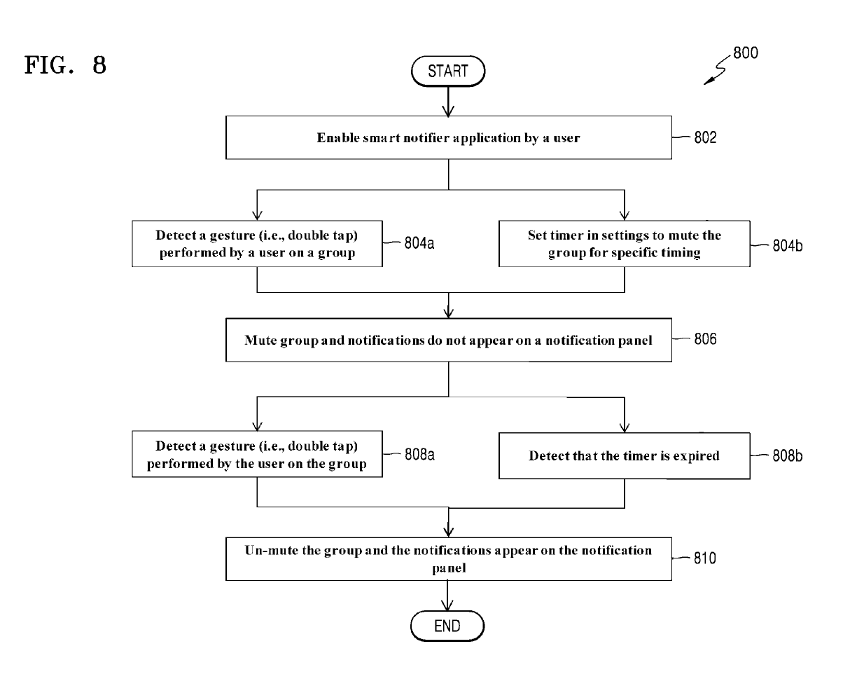

FIG. 8 is a flow chart 800 illustrating various operations performed for muting/un-muting user defined groups, according to an exemplary embodiment.

In operation 802, the method includes enabling the smart notifier application (e.g., enabling the smart notifier application based on a user input). The method may proceed to one or more operations after enabling the smart notifier application in operation 802.

In an exemplary embodiment, in operation 804a, the method includes detecting a first user input. For example, the method may include sensing whether a user enters a first input (e.g., double tap, swipe, tap and hold) with respect to a first group (i.e., a first user defined group of applications). The first user input may be a command for muting the group, which will be discussed in further detail below, according to an exemplary embodiment.

In another set of operations, in operation 804b, the method includes setting a timer for muting the group.

In operation 806, the method includes muting the group (e.g., muting alerts for notifications corresponding to applications assigned to the group). The method may proceed to one or more operations after muting the group in operation 806.

In an exemplary embodiment, in operation 808a, the method includes detecting a second user input. For example, the method may include sensing whether a user enters a second input (e.g., double tap, swipe, tap and hold) with respect to the first group. The second user input may be a command for unmuting the group, which will be discussed in greater detail below according to an exemplary embodiment.

In another exemplary embodiment, in operation 808b, the method includes detecting that the timer set in operation 804b has expired.

In operation 810, the method includes un-muting the group, which, for example, may include both un-muting alerts and allowing notifications to appear in the notification panel 112.

According to the method of an exemplary embodiment, the notification manager 110 may perform the above operations described in FIG. 8.

Various actions, acts, blocks, steps, or the like in the flow chart 800 may be performed in the order presented, in a different order or simultaneously. Further, in some exemplary embodiments, actions, acts, blocks, steps, or the like may be omitted, added, modified, skipped, or the like without departing from the scope of an inventive concept.

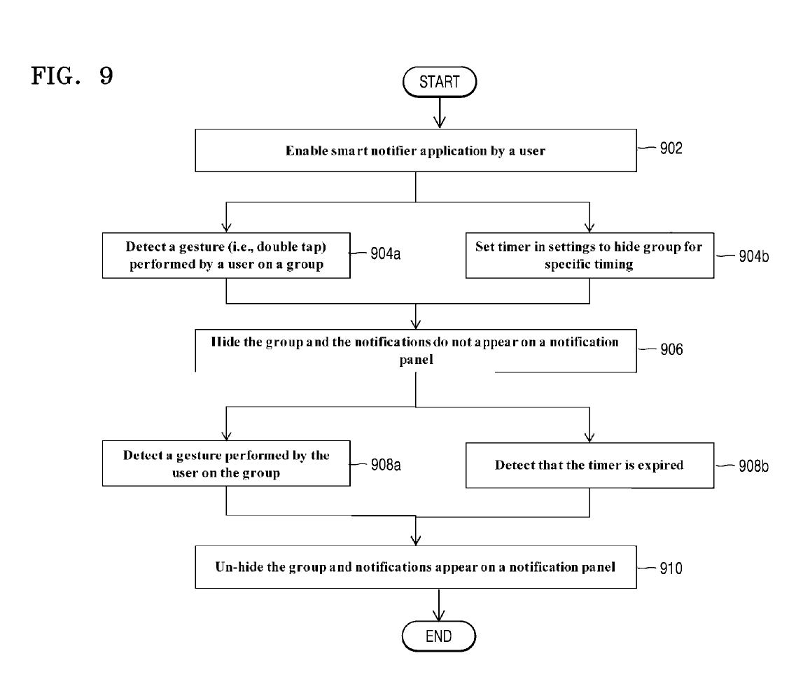

FIG. 9 is a flow chart 900 illustrating various operations performed for hiding/un-hiding user defined groups, according to an exemplary embodiment.

In operation 902, the method includes enabling the smart notifier application (e.g., enabling the smart notifier application based on a user input). The method may proceed to one or more operations after enabling the smart notifier application in operation 902.

In an exemplary embodiment, in operation 904a, the method includes detecting a first user input. For example, the method may include sensing whether a user enters a first input (e.g., double tap, swipe, tap and hold) with respect to the first group. The first user input may be a command for hiding the group, which will be discussed in greater below according to an exemplary embodiment.

In another exemplary embodiment, in operation 904b, the method includes setting a timer for hiding the group.

In operation 906, the method includes hiding the group (e.g., hiding notifications corresponding to applications assigned to the group). The method may proceed to one or more operations after hiding the group in operation 906.

In an exemplary embodiment, in operation 908a, the method includes detecting a second user input. For example, the method may include sensing whether a user enters a second input (e.g., double tap, swipe, tap and hold) with respect to the first group. The second user input may be a command for unhiding the group, which will be discussed in greater detail below according to an exemplary embodiment.

In another exemplary embodiment, in operation 908b, the method includes detecting that the timer set in operation 904b has expired.

In operation 910, the method includes un-hiding the group, which, for example, allows notifications corresponding to applications assigned to the group to appear in the notification panel 112.

According to the method of an exemplary embodiment, the notification manager 110 may perform the above operations described in FIG. 9.

Various actions, acts, blocks, steps, or the like in the flow chart 900 may be performed in the order presented, in a different order or simultaneously. Further, in some exemplary embodiments, actions, acts, blocks, steps, or the like may be omitted, added, modified, skipped, or the like without departing from the scope of an inventive concept.

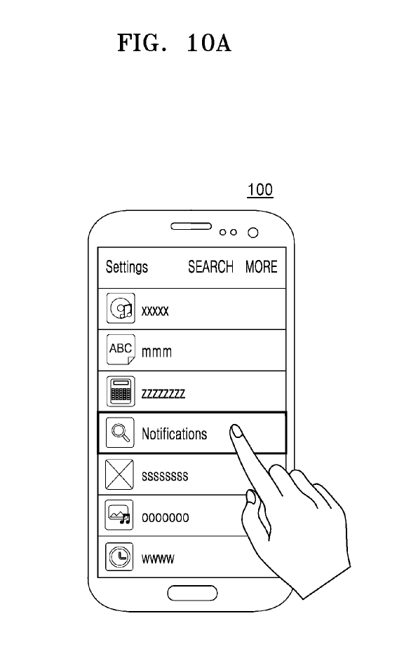

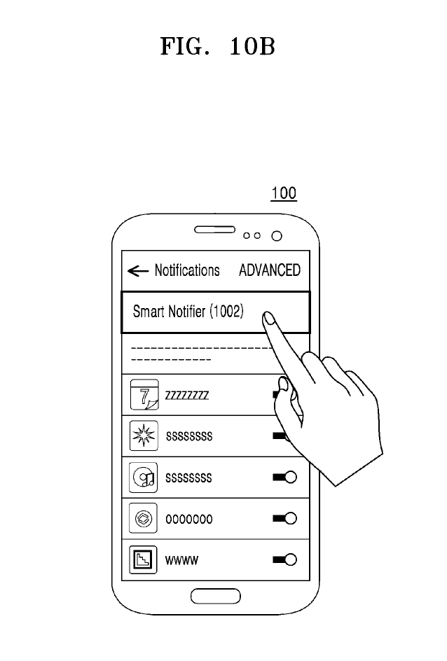

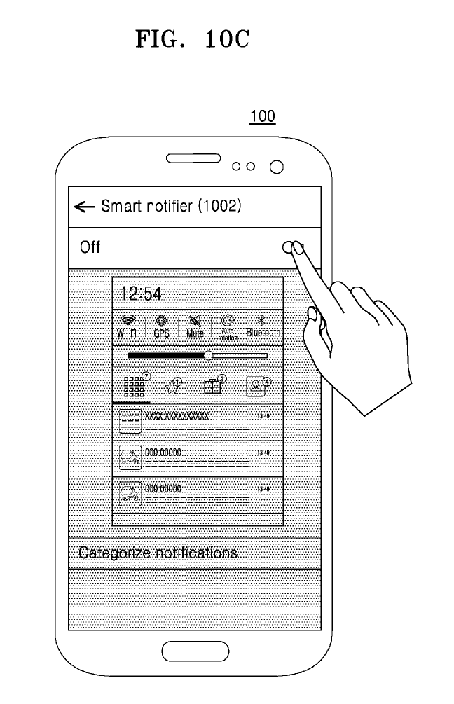

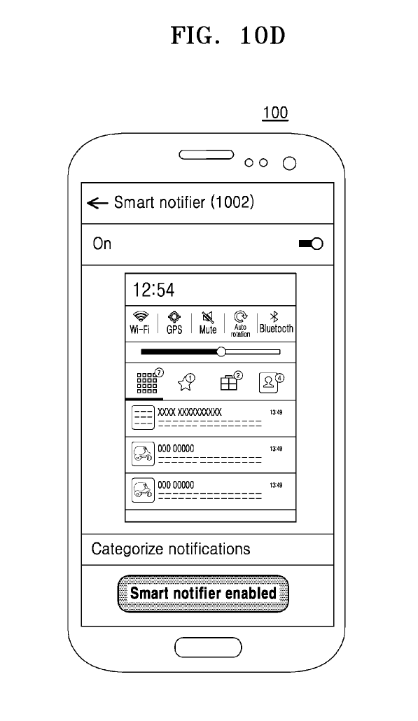

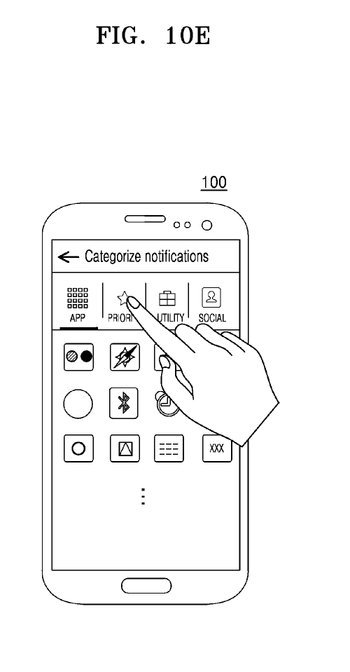

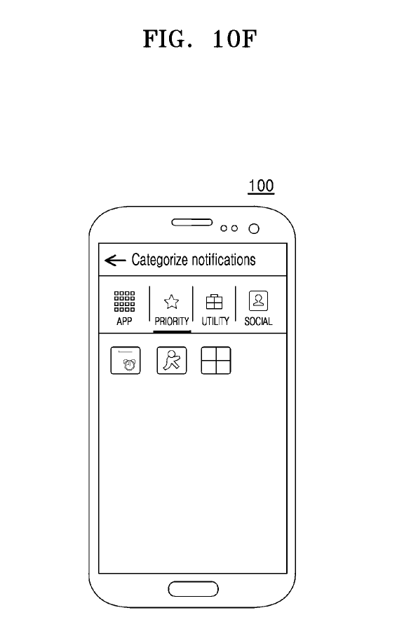

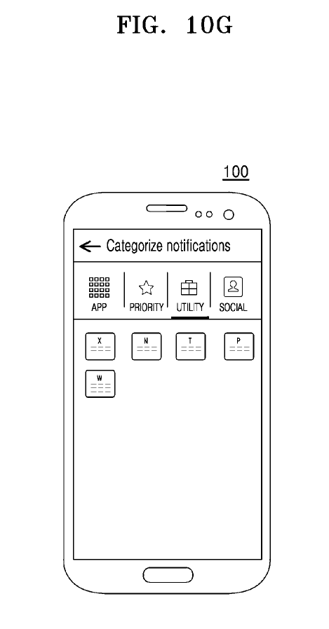

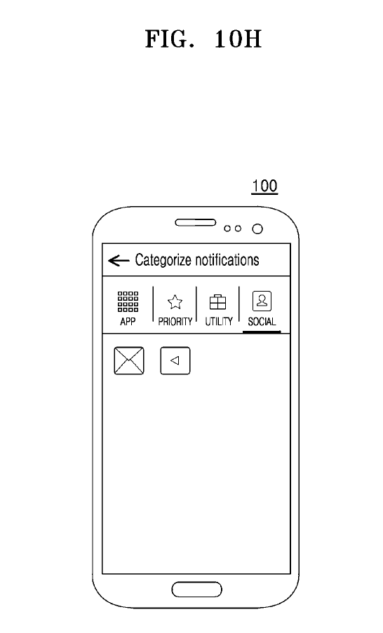

FIGS. 10A-10H illustrate a scenario in which the user enters a sequence of inputs to enable a smart notifier application 1002 (i.e., smart notifier) and manage the notifications in the notification panel 112 of the electronic device 100, according to an exemplary embodiment.

Initially, the user may select an application icon to access a settings menu of the electronic device 100. Further, the user may enter an input via the settings menu to access a notification categorization screen.

In an exemplary embodiment, once in the settings menu (shown in FIG. 10A) of the electronic device 100, the user can tap and hold a notifications tab (“Notifications”) to navigate to a notification categorization screen (later shown in FIG. 10E) where the applications can be sorted according to groups.

According to exemplary embodiments, after tapping and holding the notifications tab, the user is presented with a notifications menu (FIG. 10B). The user may select “Smart Notifier” 1002 via a user input to access a settings menu for the same.

In FIG. 10C, the user may enable the smart notifier 1002 for managing notifications in the notification panel 112 of the electronic device 100. Once the smart notifier 1002 is enabled (FIG. 10D), user defined groups, e.g., “APP”, “PRIORITY”, “UTILITY”, and “SOCIAL”, are displayed to the user (FIG. 10E).

In FIG. 10E, applications grouped under the user defined group “APP” are displayed on the display 130 of the electronic device 100. In the example of FIG. 10E, the user selects the user defined group “PRIORITY”.

As shown in FIG. 10E, applications grouped under the user defined group “PRIORITY” are then displayed on the display 130. Similarly, as shown in FIG. 10G and FIG. 10H, applications grouped under the user defined groups “UTILITY” and “SOCIAL” are displayed on the display 130 of the electronic device 100.

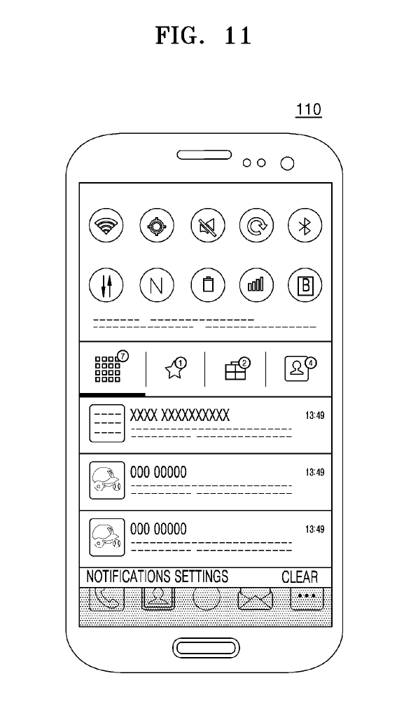

FIG. 11 is a view illustration a scenario in which the graphical element for the user defined group is displayed in the notification panel 112 of the electronic device 100, according to an exemplary embodiment. Consider a scenario where the user receives notifications associated with applications installed in the electronic device 100. After receiving the notifications, the notification manager 110 may assign one or more of the notifications to any of the user defined groups based on the plurality of parameters described above. Graphical elements for the user defined groups are displayed in the notification panel 112 of the electronic device 100.

The graphical elements may include indicators for the notifications (e.g., the number of notifications). As shown in the FIG. 11, the graphical elements represent user defined groups, and each graphical element includes an indicator indicating the present number of notifications in a corresponding user defined group. Further, the indicator indicates whether the user defined groups have been accessed by the user after receiving a new notification. For example, the notification manager 110 may indicate, for example, using a marker, which of the user defined groups is currently being accessed by the user. In another example, the notification manager 110 may update the indicators to reflect whether notifications have been accessed or cleared by the user.

In of FIG. 11, in the user defined group “ALL” (represented by a pattern of blocks), the indicator indicates that there are “SEVEN” notifications. In the user defined group “PRIORITY” (represented by a star icon), the indicator indicates that there is “ONE” notification. In the user defined group “UTILITY” (represented by a briefcase icon), the indicator indicates that there are “TWO” notifications. In the user defined group “SOCIAL”, the indicator indicates that there are “FOUR” notifications.

The notification panel 112 according to above exemplary embodiments may be integrated with existing notification panels of electronic devices, aligning above new features with existing methods of handling notifications.

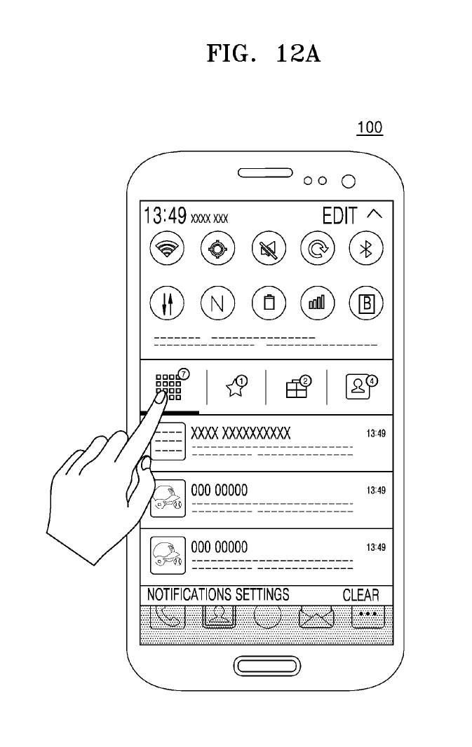

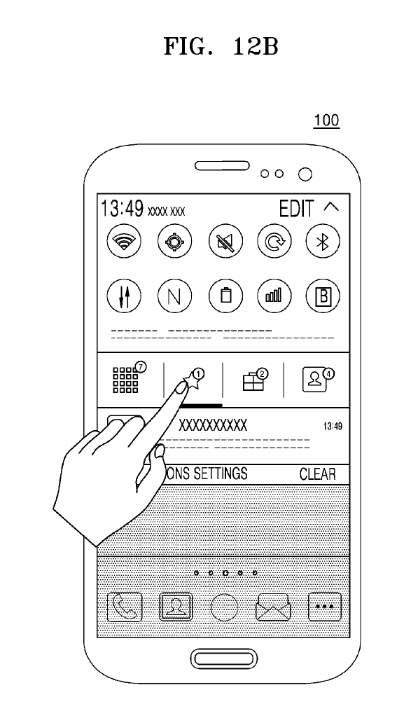

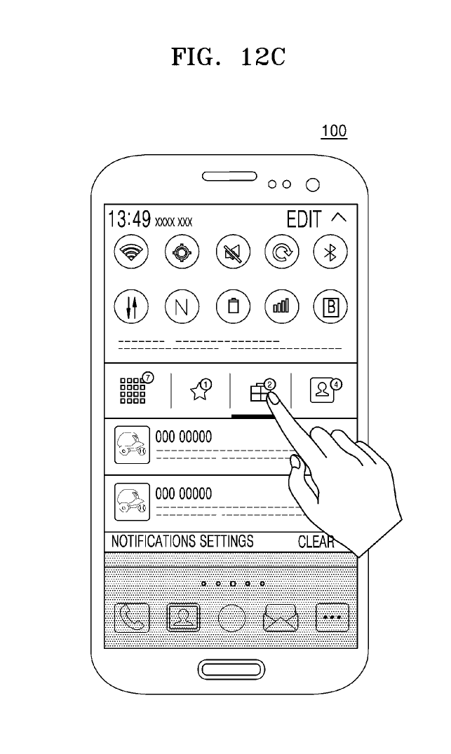

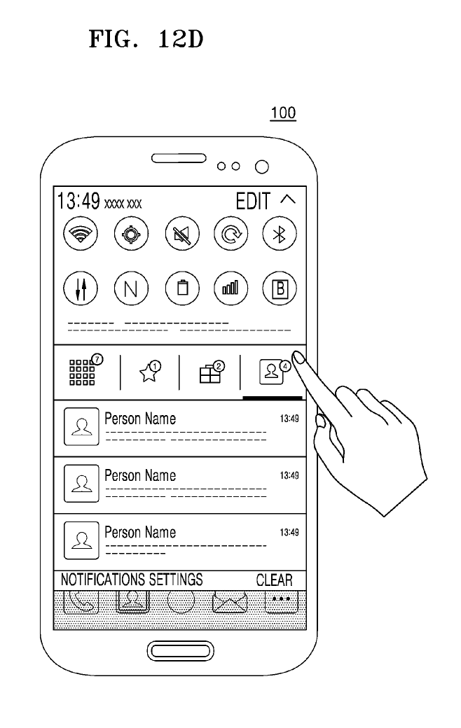

FIGS. 12A-12D are views illustrating a scenario in which indicators for the user defined groups indicate whether the user defined groups have been accessed by the user following the receipt of new notifications, according to an exemplary embodiment.

As shown in FIG. 12A, newly received notifications exist for applications assigned to the user defined groups “ALL (7)”, “PRIORITY (1)”, “UTILITY (2)”, and “SOCIAL (4)”. In an exemplary embodiment, respective indicators indicating the number of new notifications in the user defined groups may be displayed in bold or greyed-out according to user defined groups which the user has accessed.

For example, in FIG. 12A, the user selects the user defined group “ALL (7)” to access newly received notifications for applications assigned to the user defined group “ALL (7)”. The indicator “7” is greyed-out to indicate the user has accessed the user defined group “ALL (7)”. In contrast, the indicators “1”, “2”, and “4” are displayed in bold to indicate that the user has not accessed the user defined groups “PRIORITY (1)”, “UTILITY (2)”, and “SOCIAL (4)”.

Similarly, when the user selects the user defined groups “PRIORITY (1)”, “UTILITY (2)”, and “SOCIAL (4)”, the indicators “1”, “2”, and “4” are greyed-out, as shown in FIGS. 12B-12D.

According to the exemplary embodiment of the proposed method, the abovementioned indicators may indicate which of the user defined groups have been clicked/accessed by the user after receiving new notifications. The indicator may be differentiated by color, bold text, greying-out or similar to indicate whether the user defined groups have been clicked/accessed and the indicators may display the total number of notifications per group.

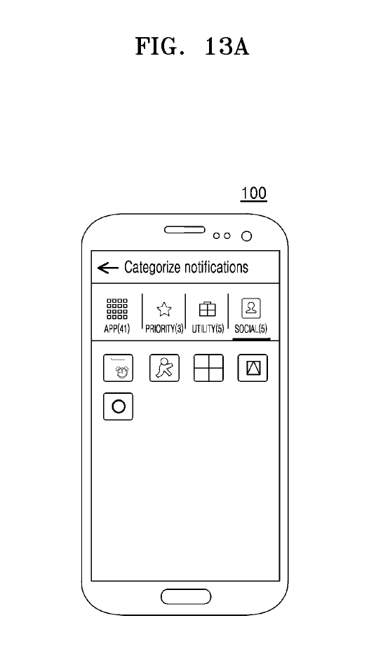

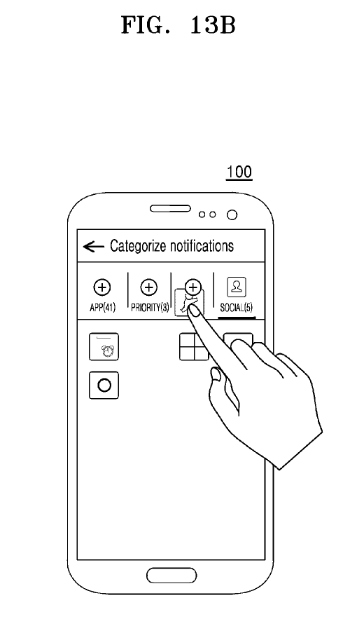

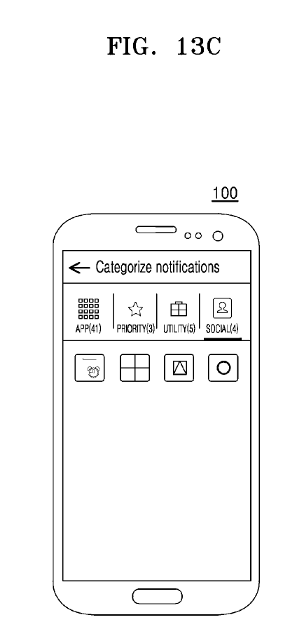

FIGS. 13A-13C are views illustrating a scenario in which the user edits applications assigned to user defined groups (e.g., user created groups), according to an exemplary embodiment.

As shown in FIG. 13A, applications grouped under the user defined group “SOCIAL” are displayed to the user on the display 130 of the electronic device 100. According to the indicator “5”, five applications are currently assigned to the user defined group “SOCIAL”.

In FIG. 13B, the user drags and drops the application “Hangouts” (which is currently assigned under user defined group “SOCIAL”) to the user defined group “UTILITY”, thereby reassigning the application “Hangouts” to the user defined group “UTILITY”.

Due to the user input, the indicator “5” for the user defined group “SOCIAL” changes to a “4”, indicating that four applications are assigned to the user defined group “SOCIAL”, as shown in FIG. 13C.

According to an exemplary embodiment of the proposed method, all applications (i.e., both unmapped and already mapped) can be mapped to any user defined group, providing the user with complete control in customizing groups and notifications according to his/her needs. The user is not limited to default groupings.

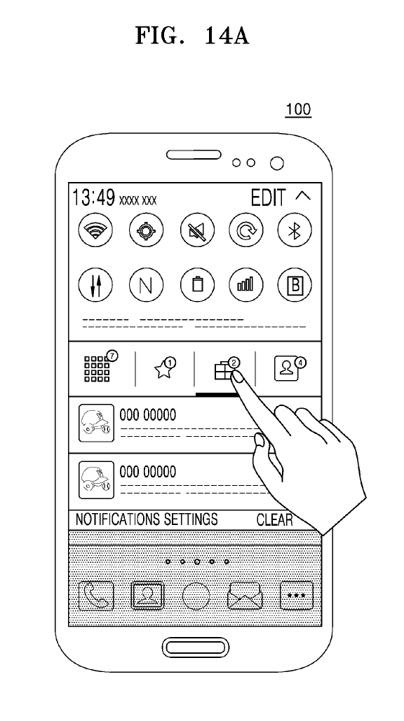

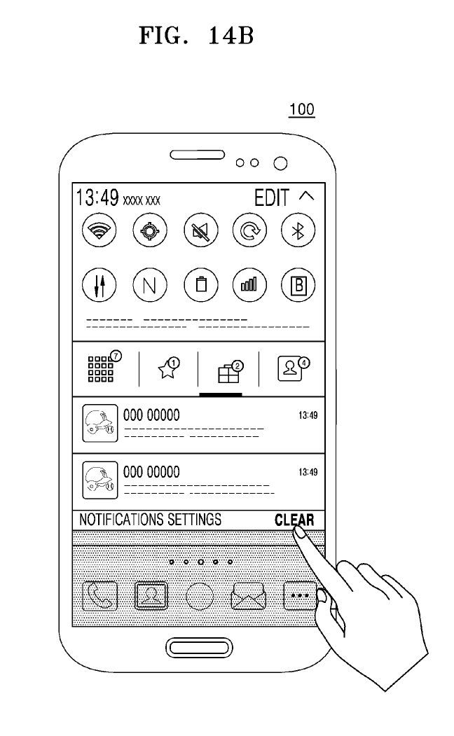

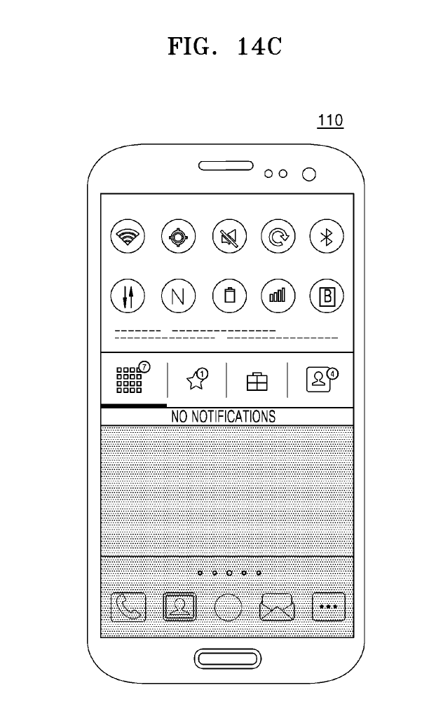

FIGS. 14A-14C are views illustrating a scenario in which the notification manager 110 provides the user with an option to clear notifications according to user defined group, according to an exemplary embodiment.

In FIG. 14A, the user selects the user defined group “UTILITY”.

As shown in FIG. 14B, the notification manager selectively displays notifications associated with the user defined group “UTILITY”. Further, the notification manager provides the user with an option to clear all notifications associated with the user defined group “UTILITY”. The user may clear each notification individually, for example, by inputting a swipe gesture at each notification, or select the “Clear Button” to clear all the notifications associated with the user defined group “UTILITY” simultaneously. In an exemplary embodiment, by selecting the “Clear Button”, all of the notifications associated with the user defined group “UTILITY” are marked for deletion and are deleted without further action from the user.

As shown in FIG. 14C, the notification manager 110 displays a “no notifications” message to the user indicating that the user defined group “UTILITY” includes no notifications.

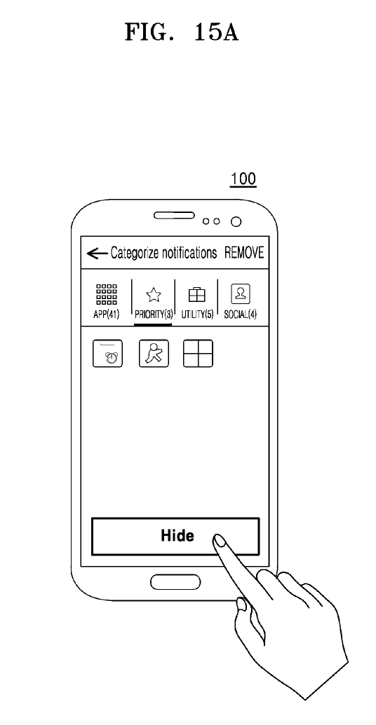

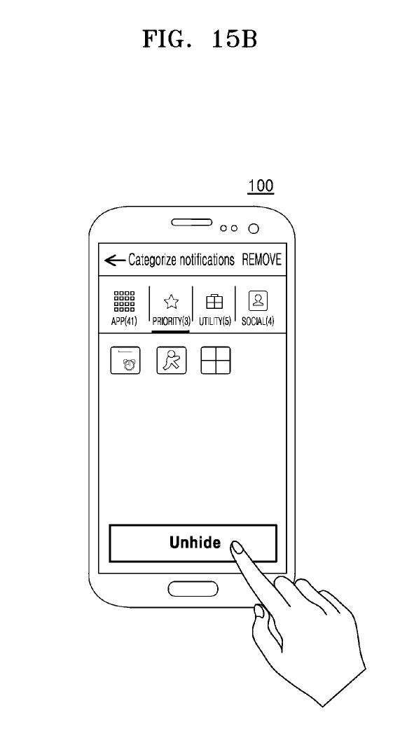

FIGS. 15A and 15B are views illustrating a scenario in which the notification manager provides the user with an option to hide/unhide notifications for user defined groups, according to an exemplary embodiment. Consider a scenario in which the user receives notifications associated with applications installed in the electronic device 100. After receiving the notifications, the notification manager 110 may assign one or more of the notifications to any user defined group based on the plurality of parameters described above.

In an exemplary embodiment shown in FIG. 15A, for the selected user defined group “PRIORITY”, the notification manager 110 displays applications assigned thereto and provides the user with an option to enable a “Hide” feature for hiding notifications associated with applications assigned to the selected user defined group “PRIORITY”. In the exemplary embodiment, all notifications for the user defined group “PRIORITY” will be hidden as long as the “Hide” feature is enabled.

As shown in FIG. 15B, the notification manager 110 provides the user with an option to disable the “Hide” feature (e.g., displays a button labeled “Unhide”). Once the user disables the “Hide” feature (e.g., selects the “Unhide” button), the notification manager 110 makes visible to the user all notifications which were received while the “Hide” feature was enabled. Further, the notification manager 110 will make visible any new notifications for the user defined group “PRIORITY”.

In related art systems and methods, notification blocking has to be enabled on an application-by-application basis. According to exemplary embodiments, by providing the group hiding feature, notification blocking can be enabled for groups of applications at a time.

Also, unlike the “Block notification” feature of related art systems and methods, which blocks notifications completely for an application, the group hiding feature according to exemplary embodiments may hide notifications without blocking them, only making them invisible to the user.

If the “Hide” feature described above is enabled for a user defined group (e.g., “PRIORITY”) and then later disabled, the user may view all notifications which belong to the user defined group “PRIORITY” and were received while the “Hide” feature was enabled. This group hiding functionality can be customized based on the user activity or predefined time setting.

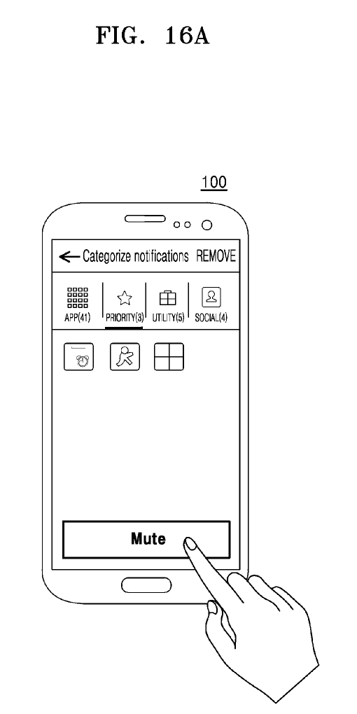

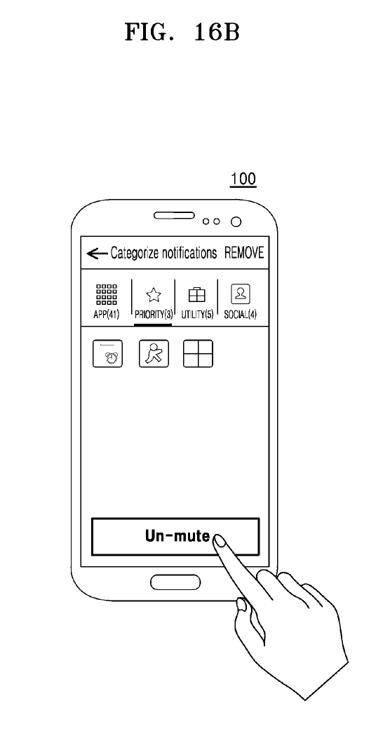

FIGS. 16A and 16B are views illustrating a scenario in which the notification manager 110 provides the user with an option to mute/un-mute notification alerts for user defined groups, according to an exemplary embodiment. Consider a scenario in which the user receives notifications associated with applications installed in the electronic device 100. After receiving the notifications, the notification manager 110 may assign one or more of the notifications to any user defined group based on the plurality of parameters described above.

In an exemplary embodiment shown in FIG. 16A, for the selected user defined group “PRIORITY”, the notification manager 110 displays applications assigned thereto and provides the user with an option to enable a “Mute” feature for muting notification alerts (i.e., sound and vibrations) associated with applications assigned to the selected user defined group “PRIORITY”. In an exemplary embodiment, all notification alerts for the user defined group “PRIORITY” will be muted as long as the “Mute” feature is enabled.

As shown in FIG. 16B, the notification manager 110 provides the user with an option to disable the “Mute” feature (e.g., displays a button labeled “Un-mute”). Once the user disables the “Mute” feature (e.g., selects the “Un-mute” button), the notification manager 110 re-enables on all notification alerts for the user defined group “PRIORITY”.

In the related art systems and methods, notification alerts have to be muted on an application-by-application basis. According to exemplary embodiments, by providing the group muting feature, notification alerts can be muted for groups of applications at a time. Further, the muting of notification alerts can also be customized based on user activity (e.g., while the user is in a meeting according to a calendar application) or a predefined time setting (e.g., from 9 pm until 7 am the next day).

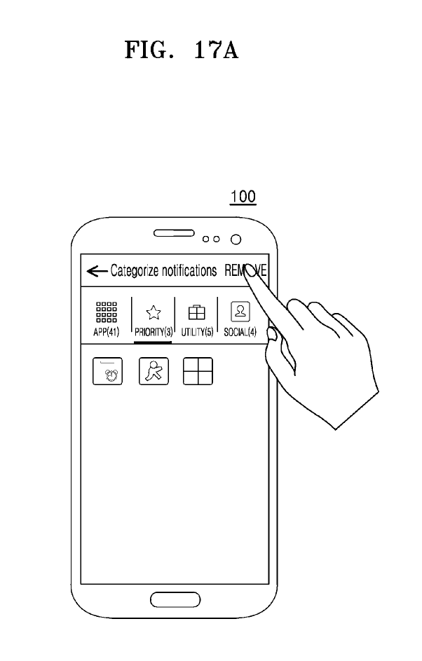

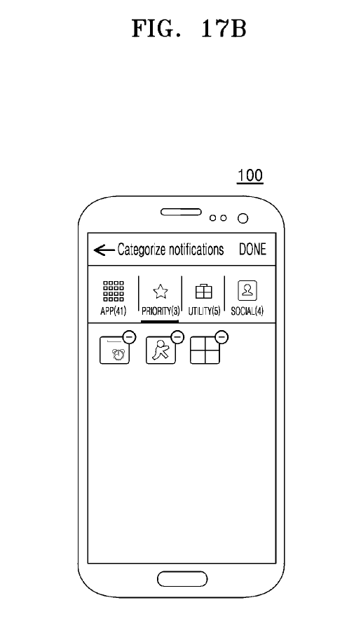

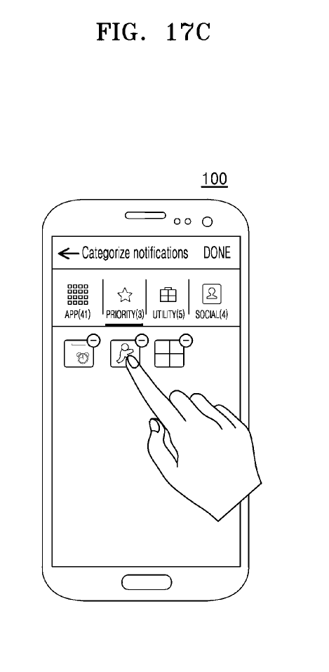

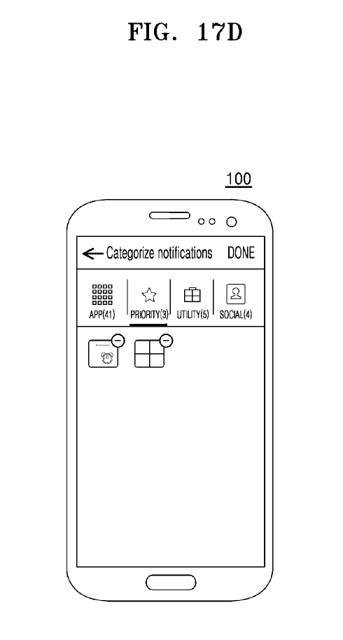

FIGS. 17A-17D are views illustrating a scenario in which the notification manager 110 provides the user with an option to remove one or more applications from a user defined group, according to an exemplary embodiment. According to an exemplary embodiment, the user may remove one or more applications from any user defined group (e.g., any group except for the group “ALL”).

As shown in FIG. 17A, applications grouped under the user defined group “PRIORITY” are displayed to the user on the display 130 of the electronic device 100. According to the indicator “3”, three applications are currently assigned to the user defined group “PRIORITY”. The user may activate the application removal feature by entering an input, e.g., tapping the “REMOVE” button.

As shown in FIG. 17B, the “REMOVE” button changes to “Done”, which the user may select at any time to deactivate the application removal feature. In an exemplary embodiment, the notification manager 110 displays a minus symbol above each of the applications assigned to the user defined group “PRIORITY”.

The user may remove one or more the applications from any selected user defined group by tapping a corresponding minus symbol. For example, referring to FIGS. 17C and 17D, the user removes the “Contacts” application from the user defined group “PRIORITY” by tapping the minus symbol adjacent the icon corresponding to the “Contacts” application. Further, although not shown, the user may remove all the applications from a user defined group with a single input (e.g., a “Remove All” button).

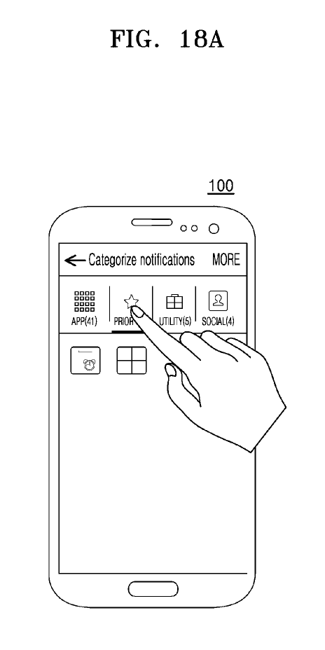

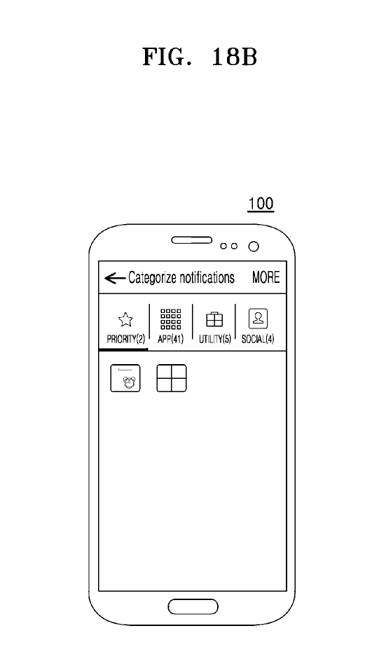

FIGS. 18A-18B are views illustrating a scenario in which the notification manager 110 provides the user with an option to arrange user defined groups in the notification panel 112, according to an exemplary embodiment. As shown in the FIG. 18A, the notifications are grouped into “ALL”, “PRIORITY”, “SOCIAL”, and “UTILITY”. However, the notification manager 110 provides the user with an option to create custom user defined groups. Further, the user can then map applications to the user defined groups based on his/her preference.

Further, the relative positioning of the user defined groups in the notification panel 112 (i.e., horizontal panel) is modifiable by the user. The notification manager 110 may display notifications to the user based on the order in which the user defined groups are positioned in the notification panel 112. Such a feature of an exemplary embodiment provides the user with flexibility regarding which notifications to view.

For example, as shown in FIGS. 18A and 18B, the user drags and drops the user defined group “PRIORITY” from a position second from the left (second tab position) to a leftmost position (first tab position). As a result, when the user enters an input to view notifications (e.g., a swipe down input), the notification manager 110 only displays notifications for applications assigned to the user defined group “PRIORITY”. Upon entering an additional input (e.g., a second swipe down input), the notification manager 110 may display all notifications, since the group “ALL” follows the user defined group “PRIORITY”.

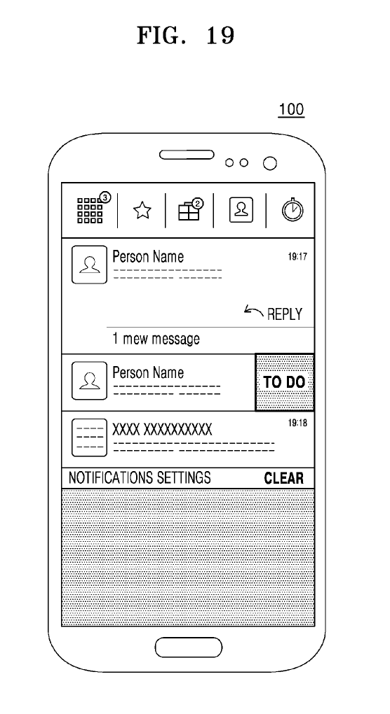

FIG. 19 is a view illustrating a scenario in which the user creates a to-do notification, according to an exemplary embodiment. For example, the user receives a notification associated with a messaging application.

After receiving the notification, the notification manager 110 identifies which user defined group the notification belongs to, based on the plurality of parameters such as the ones described above. The notification manager 110 displays a graphical element corresponding to the identified user defined group (e.g., a briefcase icon corresponding to a user defined group “BUSINESS”) in the notification panel 112 of the electronic device 100, along with a graphical representation of the notification (e.g., a “2”).

In an example illustrated in FIG. 19, the notification manager 110 detects a user input selecting the user defined group “ALL” displayed in the notification panel 112. In response, the notification manager 110 displays a marker below the user defined group “ALL” and displays all unread notifications.

The user enters an input (i.e., swipe right gesture) on the message notification to create a to-do notification corresponding thereto. For example, the to-do notification may be a reminder to view or reply to the message.

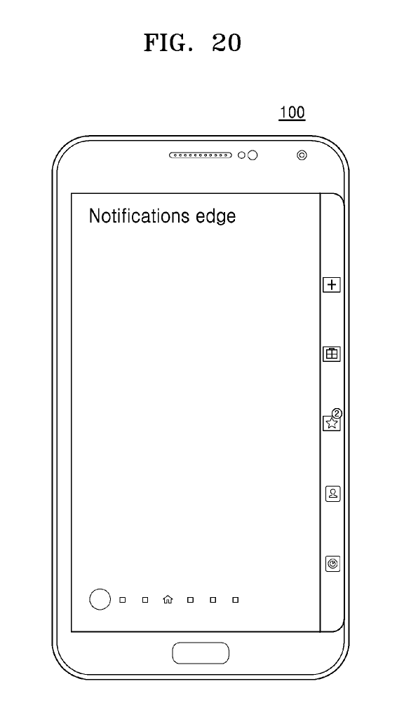

FIG. 20 is a view illustrating a scenario for managing notifications in an edge portion of the electronic device 100, according to an exemplary embodiment. As shown in the FIG. 20, the notification manager 110 may display, in the edge portion of the electronic device 100, graphical elements corresponding to user defined groups (e.g., a star icon corresponding to a user defined group “UTILITY”), each graphical element including an indicator indicating the number of unread notifications (e.g., a “2” indicating the number of unread notifications for applications included in the user defined group “UTILITY”).

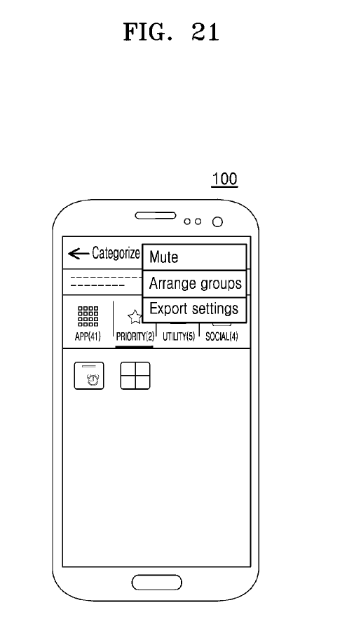

FIG. 21 is a view illustrating a scenario in which the notification manager 110 provides the user with multiple options for muting user defined groups, arranging user defined groups, and exporting settings to another electronic device, according to an exemplary embodiment. As shown in FIG. 21, the notification manager 110 provides an option to mute user defined groups, and the user may enable the option to avoid being disturbed during set hours. Further, the groups are automatically arranged based on application usage and receipt time of notifications included in the groups and the applied settings for the electronic device 100 can be exported to another electronic device.

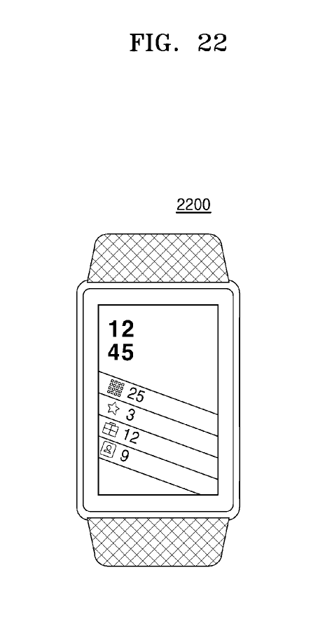

FIG. 22 is a view illustrating an example scenario in which the smart notifier application is applied to a wearable device 1900, according to an exemplary embodiment. As shown in the FIG. 22, the smart notifier application is installed on the wearable device 2200. The selected user defined groups can be muted on a master device (e.g., electronic device 100) or a slave device (e.g., wearable device 2200) so that notifications are displayed only when required by the user. The option to mute notifications may be controlled via the master device, the slave device, or a combination thereof.

Although exemplary embodiments are explained in conjunction with an electronic device and a wearable device, it is to be understood that other exemplary embodiments are not limited thereto. An inventive concept of the present disclosure can equally be applied to IoT devices. The functionalities of the electronic device as described above can be performed by IoT devices without departing from the scope of an inventive concept.

Exemplary embodiments described herein may be applied to a QuickPanel displayed by the electronic device 100. For example, when the smart notifier application is active, the notification manager 110 may display one or more of the user defined groups (i.e., the graphical elements corresponding to the user defined groups) on the QuickPanel, along with the respective indicators corresponding thereto, based on user preference.

Referring back to the user defined groups described with respect to FIGS. 12A-12D, the notification manager 110 may provide the user with an option to display notifications on the QuickPanel according to user defined group.

For example, once the user enables an option to display notifications in the QuickPanel for the user defined group “PRIORITY”, the notification manager 110 makes all notifications for the user defined group “PRIORITY” visible and accessible via the QuickPanel. Via the QuickPanel, the user may view and access the notifications and control the notifications as described with respect to exemplary embodiments described above.

In another example, the user enables options to display notifications in the QuickPanel for the user defined groups “PRIORITY” and “UTILITY”, and the notification manager 110 makes all notifications for the user defined groups “PRIORITY” and “UTILITY” visible and accessible via the QuickPanel. Via the QuickPanel, the user may view and access the notifications and control the notifications as described with respect to exemplary embodiments described above.

In an exemplary embodiment, using the quickpanel, the user may apply any of the above mentioned user actions (e.g., hiding notifications, creating a to-do notification) to individual notifications or to groups of notifications without exiting the QuickPanel. For example, a user may be busy with work, and using the QuickPanel, the user may mute all notifications for applications belonging to “SOCIAL” and “UTILITY”.

Exemplary embodiments described herein may be applied to devices in a locked state.

For example, when the smart notifier application is active and the electronic device 100 is in a locked state, the notification manager 110 may display one or more of the user defined groups (i.e., the graphical elements corresponding to the user defined groups) on the lockscreen, along with the respective indicators corresponding thereto.

The notification manager 110 may provide the user with an option to display notifications on the lockscreen according to user defined group. Enabling the option, the user may thereby adjust privacy settings of the electronic device 100 such that the electronic device 100 displays notifications according to one or more user defined groups even when in a locked state.

For example, the user may enable an option to make notifications for the user defined group “PRIORITY” visible on the lockscreen, and the notification manager 110 may display and make accessible notifications for the user defined group “PRIORITY” even when the electronic device 100 is in a locked state. Via the lockscreen, the user may view, access, and control notifications as described with respect to exemplary embodiments already described herein, without unlocking the device.

In another example, the user may enable options to make notifications for the user defined groups “PRIORITY” and “UTILITY” visible on the lockscreen, and the notification manager 110 may display and make accessible notifications for the user defined groups “PRIORITY” and “UTILITY” even when the electronic device 100 is in a locked state.

In an exemplary embodiment, via the lockscreen, the user may apply any of the above mentioned user actions (e.g., hiding notifications, creating a to-do notification) to individual notifications or to groups of notifications without exiting the lockscreen. For example, a user may be busy with work, and via the lockscreen, the user may mute all notifications for applications belonging to “SOCIAL” and “UTILITY”.

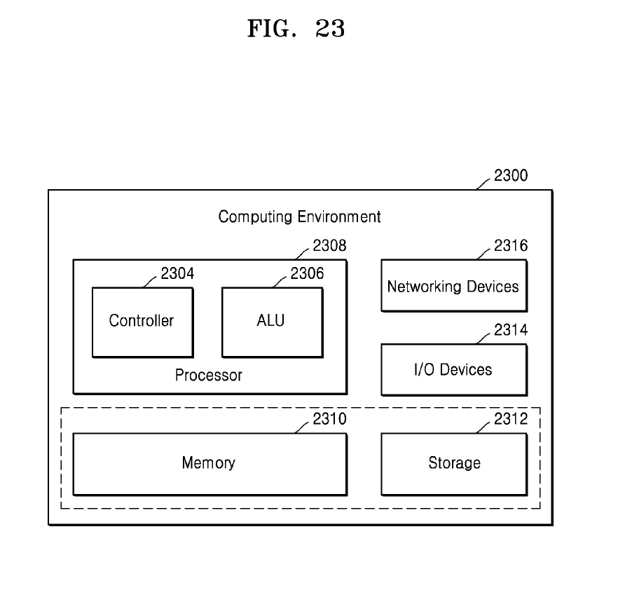

FIG. 23 is a block diagram illustrating a computing environment 2300 implementing the method and the electronic device 100 of managing notifications in the notification panel 112 or edge portion of the electronic device 100, according to an exemplary embodiment. As depicted in FIG. 23, the computing environment 2300 comprises at least one processor 2308 equipped with a controller 2304 and an Arithmetic Logic Unit (ALU) 2306, a memory 2310, a storage 2312, a plurality of networking devices 2316, and a plurality of Input/Output (I/O) devices 2314. The processor 2308 is responsible for processing the instructions of the operations described above. The processor 2308 operates and executes processes based on commands received from the controller 2304. Further, any logical and arithmetic operations involved in the execution of the instructions may be computed with the help of the ALU 2306.

The overall computing environment 2300 can be composed of multiple homogeneous or heterogeneous cores, multiple CPUs of different kinds, special media and other accelerators. Multiple processor 2308 may be located on a single chip or over multiple chips.

The scheme comprising of instructions and codes required for the implementation are stored in the memory 2310, the storage 2312, or both. At the time of execution, the instructions may be fetched from the memory 2310 or the storage 2312 and executed by the processor 2308.

In the case of any hardware implementations, various networking devices 2316 or external I/O devices 2314 may be connected to the computing environment through the networking unit and the I/O device unit to support the implementations.

Exemplary embodiments disclosed herein can be implemented through at least one software program running on at least one hardware device and performing network management functions to control the elements. The elements shown in the FIGS. 1 through 23 include blocks which can be at least one of a hardware device, or a combination of hardware device and software units.

The foregoing description of the exemplary embodiments will so fully reveal the general nature of exemplary embodiments herein that others can, by applying current knowledge, readily modify or adapt for various applications such specific exemplary embodiments without departing from the generic concept, and, therefore, such adaptations and modifications should and are intended to be comprehended within the meaning and range of equivalents of exemplary embodiments. It is to be understood that the phraseology or terminology employed herein is for the purpose of description and not of limitation. Therefore, while the present disclosure herein have been described in terms of exemplary embodiments, those skilled in the art will recognize that exemplary embodiments herein can be practiced with modification within the spirit and scope of an inventive concept, as defined by the appended claims as well as their equivalents.

What we claim is:

1. A method of managing notifications in an electronic device, the method comprising:
receiving, by the electronic device, a notification associated with an application;
assigning the received notification to a user defined group based on a plurality of parameters;
displaying, on a display of the electronic device, a graphical element corresponding to the user defined group;
detecting a first user input comprising a selection of the graphical element;
detecting a second user input; and
applying an action to the notification based on the first user input and the second user input,
wherein the action is selected from at least one of:
hiding at least one of the notification and another notification for at least one other application assigned to the user defined group,
unhiding said at least one of the notification and said another notification for the at least one other application assigned to the user defined group,
muting at least one of a first notification alert for the application and a second notification alert for the at least one other application assigned to the user defined group,
unmuting said at least one of the first notification alert for the application and the second notification alert for the at least one other application assigned to the user defined group,
removing said at least one of the application and the at least one other application from the user defined group, and
generating at least one to-do notification.

2. The method of claim 1, wherein:
the receiving the notification comprises receiving a plurality of notifications,
the assigning comprises assigning the plurality of notifications to at least one of the user defined group and another user defined group, and
the method further comprises dynamically organizing the plurality of notifications in a plurality of user defined groups comprising the at least one of the user defined group and said another user defined group, based on a priority level associated with each of the plurality of notifications.

3. The method of claim 1, wherein the plurality of parameters comprises at least one of a user action, a user activity, a notification content, a user location, and an application type.

4. The method of claim 1, wherein the graphical element comprises an indicator indicating a number of notifications unread by a user.

5. The method of claim 1, wherein:
the receiving the notification comprises receiving a plurality of notifications,
the assigning comprises assigning the notifications to at least one of the user defined group and another user defined group, and
the method further comprises automatically arranging the user defined group and said another user defined group, based on at least one of usage of the plurality of notifications and receipt times of the plurality of notifications.

6. The method of claim 1, wherein the user defined group comprises an indicator indicating whether the user defined group has been accessed by the user after receiving at least one new notification.

7. An electronic device for managing notifications comprising:
a receiver configured to receive a notification associated with an application;
a processor configured to assign the notification, received by the receiver, to a user defined group based on a plurality of parameters; and
a display configured to display a graphical element corresponding to the user defined group,
wherein, in response to the processor receiving a first user input indicating a selection of the graphical element and a second user input, the processor is further configured to apply an action to the notification based on the first user input and the second user input, and
wherein the action is selected from at least one of:
hiding at least one of the notification and another notification for at least one other application assigned to the user defined group,
unhiding said at least one of the notification and said another notification for the at least one other application assigned to the user defined group,
muting at least one of a first notification alert for the application and a second notification alert for the at least one other application assigned to the user defined group,
unmuting said at least one of the first notification alert for the application and the second notification alert for the at least one other application assigned to the user defined group,
removing said at least one of the application and the at least one other application from the user defined group, and
generating at least one to-do notification.

8. The electronic device of claim 7, wherein:
the receiver is further configured to receive a plurality of notifications including the notification,
the processor is further configured to assign the plurality of the notifications to at least one of the user defined group and another user defined group, and to dynamically organize the plurality of notifications in the user defined group and said another user defined group, based on a priority level associated with each of the plurality of notifications.

9. The electronic device of claim 7, wherein the plurality of parameters comprises at least one of a user action, a user activity, a notification content, a user location, current time, and an application type.

10. The electronic device of claim 9, wherein the display is further configured to display, based on at least one of the plurality of parameters, an application for recommending at least one place.

11. The electronic device of claim 7, wherein the graphical element comprises an indicator indicating a number of notifications unread by the user.

12. The electronic device of claim 7, wherein:
the receiver is further configured to receive a plurality of notifications comprising the notification,
the processor is further configured to assign the plurality of notifications to at least one of the user defined group and another user defined group, and to automatically arrange the user defined group and said another user defined group based on at least one of a usage of the plurality of notifications and receipt times of the plurality of notifications.

13. The electronic device of claim 7, wherein the user defined group comprises an indicator indicating whether the user defined group has been accessed by a user after receiving at least one new notification.

14. An electronic device for managing notifications comprising:
a receiver configured to receive a notification associated with an application;
a processor configured to assign the notification to a user defined group based on a plurality of parameters; and
a display configured to display, in an edge portion of the electronic device, a graphical element corresponding to the user defined group,
wherein the processor is further configured to, in response to receiving a first user input indicating a selection of the graphical element and receiving a second user input, apply an action to the notification based on the first user input and the second user input, and
wherein the action is selected from at least one of:
hiding at least one of the notification and another notification for at least one other application assigned to the user defined group,
unhiding said at least one of the notification and said another notification for the at least one other application assigned to the user defined group,
muting at least one of a first notification alert for the application and a second notification alert for the at least one other application assigned to the user defined group,
unmuting said at least one of the first notification alert for the application and the second notification alert for the at least one other application assigned to the user defined group,
removing said at least one of the application and said at least one other application from the user defined group, and
generating at least one to-do notification.

15. The electronic device of claim 14, wherein:
the receiver is further configured to receive a plurality of notifications comprising the notification,
the processor is further configured to assign the plurality of notifications to at least one of the user defined group and another user defined group, and dynamically organize the plurality of notifications in the user defined group and said another user defined group, based on a priority level associated with each of the plurality of notifications.

16. The electronic device of claim 14, wherein the plurality of parameters comprises at least one of a user action, a user activity, a notification content, a current time, a user location, and an application type.

17. The electronic device of claim 14, wherein the graphical element comprises an indicator indicating a number of notifications unread by a user.

18. The electronic device of claim 14, wherein:
the receiver is further configured to receive a plurality of notifications comprising the notification,
the processor is further configured to assign the plurality of notifications to at least one of the user defined group and another user defined group, and automatically arrange the user defined group and said another user defined group, based on at least one of usage of the plurality of notifications and receipt times of the plurality of notifications.

19. The electronic device of claim 14, wherein the user defined group comprises an indicator indicating whether the user defined group has been accessed by a user after receiving at least one new notification.

20. The electronic device of claim 14, wherein the display is further configured to display, based on at least one of the plurality of parameters, an application for recommending at least one place.
